(19) United States
(12) Patent Application Publication
(10) Pub. No.: US 2011/0062299 A1
(43) Pub. Date: Mar. 17, 2011

(54) Car computer/LCD monitor holder

(76) Inventor: Wen-Feng Tsai, Taipei (TW)

(21) Appl. No.: 12/584,985

(22) Filed: Sep. 16, 2009

(51) Int. Cl. F16M 13/00

(52) U.S. Cl. 248/231.41

(57) ABSTRACT

A car computer/LCD monitor holder includes a bracket for holding a car computer/LCD monitor and a vehicle computer/LCD monitor arm mountable on a part inside a car to support the bracket. The bracket includes a platform, two clamping plates slidably mounted in a respective bottom sliding groove on the bottom side of the platform and movable relative to each other, two compression springs respectively mounted in the bottom sliding grooves of the platform to force the clamping plates apart, two stop members respectively pivotally mounted on the bottom side of the platform and engaged with a respective longitudinal series of sloping teeth on each clamping plate, and two biasing springs respectively mounted in the bottom side of the platform to force the stop members into engagement with the longitudinal series of sloping teeth of the clamping plate.

### BACKGROUND OF THE INVENTION

1. Field of the Invention

The present invention relates to car computer/LCD monitor holders and more particularly, to such a car computer/LCD monitor holder, which fits any of a variety of car computers and LCD monitors.

2. Description of the Related Art

Following fast development of wireless transmission technology, many different mobile electronic devices such as computers and LCD monitors are allowed for use in motor vehicles. For holding a computer or LCD monitor in a car stably, a car computer/LCD monitor holder may be used. However, regular car computer/LCD monitor holders are specifically designed for holding a specific model of computer or LCD monitor. For holding a different model of computer or LCD monitor in a car, a different computer/LCD monitor holder must be used.

### SUMMARY OF THE INVENTION

The present invention has been accomplished under the circumstances in view. It is one object of the present invention to provide a car computer/LCD monitor holder, which is conveniently adjustable for holding any of a variety of car computers and LCD monitors.

To achieve this and other objects of the present invention, a car computer/LCD monitor holder comprises a bracket for holding a car computer/LCD monitor and a vehicle computer/LCD monitor arm mountable on a part inside a car to support the bracket. The bracket comprises a platform, two clamping plates slidably mounted in a respective bottom sliding groove on the bottom side of the platform and movable relative to each other, two compression springs respectively mounted in the bottom sliding grooves of the platform to force the clamping plates apart, two stop members respectively pivotally mounted on the bottom side of the platform and engaged with a respective longitudinal series of sloping teeth on each clamping plate, and two biasing springs respectively mounted in the bottom side of the platform to force the stop members into engagement with the longitudinal series of sloping teeth of the clamping plate.

Further, the vehicle computer/LCD monitor arm comprises a top mounting assembly pivotally connected to the bottom side of the platform of the bracket and adjustably locked thereto by a locking mechanism thereof, a bottom mounting assembly for mounting on a part inside a car, and a plurality of links connected in series between the top mounting assembly and the bottom mounting assembly.

### BRIEF DESCRIPTION OF THE DRAWINGS

FIG. 1 is an elevational view showing a car computer/LCD monitor bracket fastened to a vehicle computer/LCD monitor arm according to the present invention.

FIG. 2 is an oblique top elevation of the car computer/LCD monitor bracket according to the present invention.

FIG. 3 is an oblique bottom elevation of the car computer/LCD monitor bracket according to the present invention.

FIG. 4 is an exploded of the car computer/LCD monitor bracket according to the present invention.

FIG. 5 is an elevational view in an enlarged scale of the vehicle computer/LCD monitor arm shown in FIG. 1.

FIG. 7 is an exploded view of the vehicle computer/LCD monitor arm shown in FIG. 5.

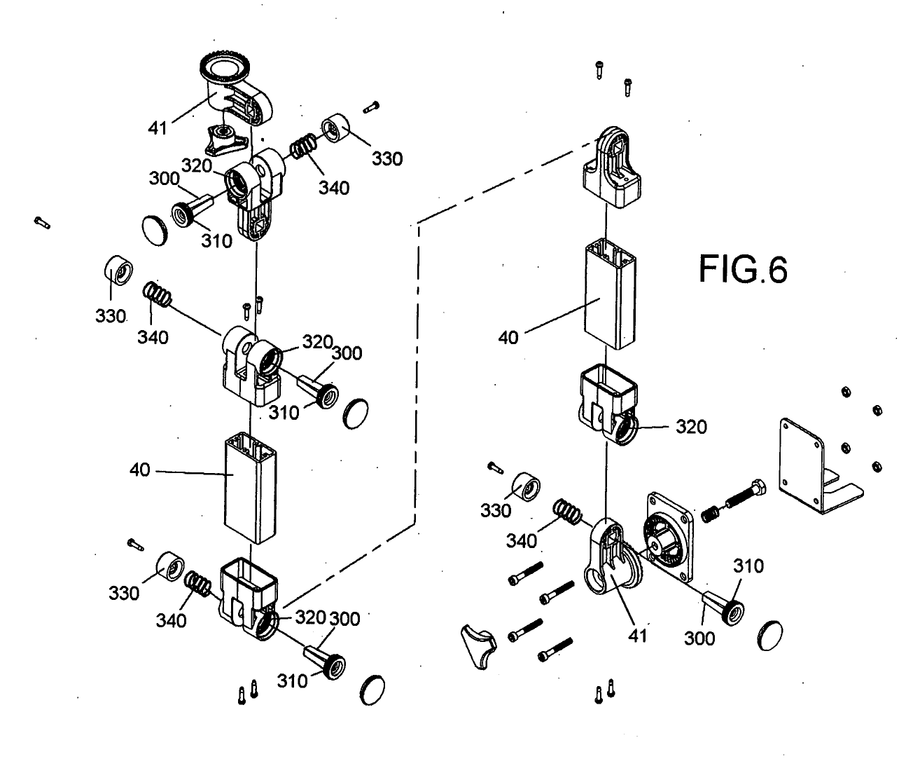

### DETAILED DESCRIPTION OF THE PREFERRED EMBODIMENT

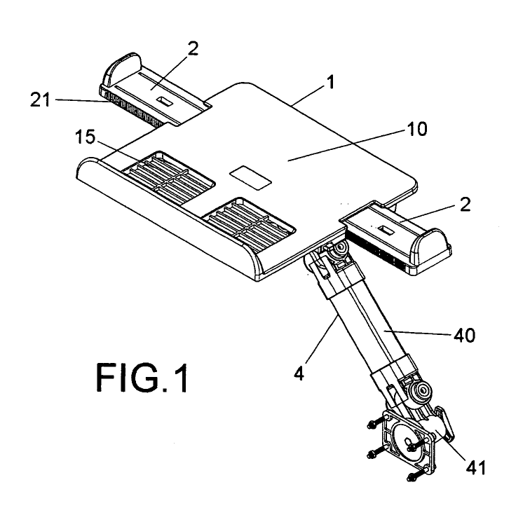

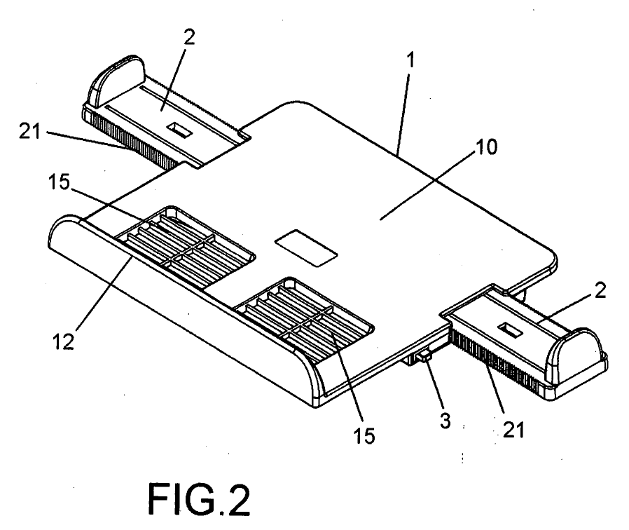

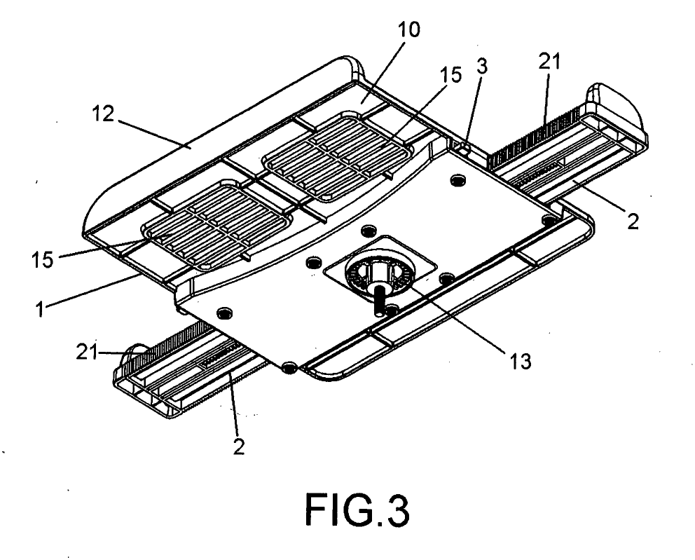

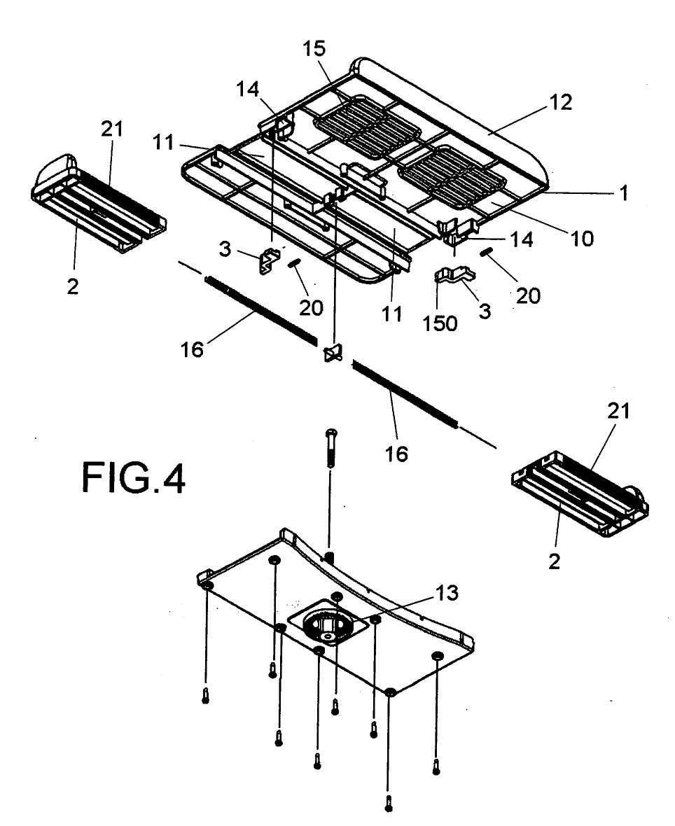

Referring to FIGS. 1-4, a car computer/LCD monitor bracket in accordance with the present invention is shown comprising a platform 1, two clamping plates 2 and two stop members 3.

The platform 1 comprises a flat base panel 10 that has an upright side flange 12 perpendicularly extended from one of four peripheral sides thereof, a plurality of air vents 14 cut through top and bottom walls thereof and two bottom sliding grooves 11 transversely located on the bottom wall and extending in reversed directions, a bottom mount 13 affixed to the bottom wall of the flat base panel 10. The two clamping plates 2 are respectively inserted into the bottom sliding grooves 11 and movably set between the flat base panel 10 and the bottom mount 13, each having a longitudinal series of sloping teeth 21 located on one lateral side thereof. Two compression springs 16 are respectively mounted in the bottom sliding grooves 11 and stopped between the inner close ends of the respective bottom sliding grooves 11 and the inner ends of the clamping plates 2 to impart an outward force to the respective clamping plates 2. The two stop members 3 are respectively pivotally mounted on the bottom wall of the flat base panel 10 at one lateral side relative to the bottom sliding grooves 11, each having a rear end supported on a respective spring member 20 at the bottom wall of the flat base panel 10 and a front end terminating in an engagement tooth 150. The spring member 20 biases the respective stop member 3, forcing the engagement tooth 150 into engagement with the longitudinal series of sloping teeth 21 of the associating clamping plate 2. Subject to engagement between the engagement teeth 150 of the stop members 20 and the longitudinal series of sloping teeth 21 of the clamping plates 2, the clamping plates 2 can be moved inwardly toward each other along the respective bottom sliding grooves 11 and are prohibited from being moved outwards toward the outside of the flat base panel 10. Further, the bottom mount 13 can be pivotally mounted on a vehicle computer/LCD monitor arm 4 that comprises two mounting assemblies 41 and a plurality of links 40 connected in series between the two mounting assemblies 41.

During the use of the present invention, bias the stop members 3 to compress the associating spring members 20 and to disengage the engagement teeth 150 of the stop members 3 from the longitudinal series of sloping teeth 21 of the associating clamping plates 2. At this time, the compression springs 20 force the clamping plates 2 outwards along the bottom sliding grooves 11 to be extended position. Thus, the user can place the computer or LCD monitor on the flat base panel 10 of the platform 1. After the computer or LCD monitor has been placed on the flat base panel 10 of the platform 1 and stopped against the upright side flange 12, the two clamping plates 2 are moved inwards toward each other and closely attached to two opposite sides of the computer or LCD monitor. When released the hands at this time, the engagement teeth 150 of the stop members 3 are engaged with the longitudinal series of sloping teeth 21 of the associating clamping plates 2 to prohibit the clamping plates 2 from backward displacement.

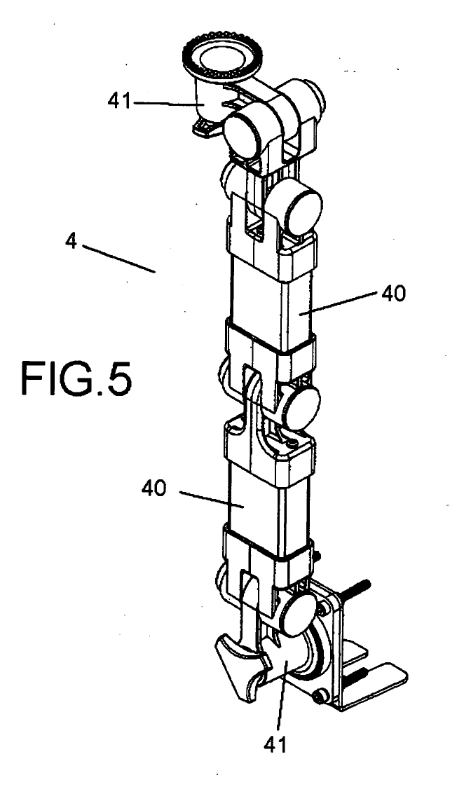

Referring to FIGS. 5 and 6 and FIG. 1 again, the bottom mount 13 of the platform 1 is affixed to the top-sided mounting assembly 41 of the vehicle computer/LCD monitor arm 4. Thus, the car computer/LCD monitor bracket and the vehicle computer/LCD monitor arm 4 form a vehicle car computer/LCD monitor holder. The tilting angle of the bottom mount 13 is adjustable relative to the top-sided mounting assembly 41 of the vehicle computer/LCD monitor arm 4. During adjustment of the tilting angle of the bottom mount 13, press the locking nut 330 to move the associating locking bolt 300 backwards so as to disengage the toothed portion 310 of the locking bolt 300 from the inner toothed portion 320 of the respective top-sided mounting assembly 41, and then adjust the platform 1 to the desired tilting angle. After the platform 1 has been adjusted to the desired tilting angle, release the hand from the locking nut 330 for enabling the associating spring member 340 to move the locking nut 330 and the locking bolt 300 to their former positions so that the toothed portion 310 of the locking bolt 300 is forced into engagement with the inner toothed portion 320 of the respective top-sided mounting assembly 41 again, locking the bottom mount 13 of the platform 1 to the top-sided mounting assembly 41 of the vehicle computer/LCD monitor arm 4.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A car computer/LCD monitor holder, comprising a bracket for holding a car computer/LCD monitor, said bracket comprising:
a platform, said platform comprising a flat base panel, said flat base panel having an upright side flange perpendicularly extended from one of four peripheral sides thereof, a plurality of air vents cut through top and bottom walls thereof and two bottom sliding grooves transversely located on the bottom wall and extending in reversed directions, a bottom mount affixed to the bottom wall of said flat base panel;
two clamping plates respectively inserted into the bottom sliding grooves of said flat base panel and movably set between said flat base panel and said bottom mount, each said clamping plate having a longitudinal series of sloping teeth located on one lateral side thereof;
two compression springs respectively mounted in the bottom sliding grooves of said flat bottom panel and respectively stopped between an inner close end of each of said two bottom sliding grooves and an inner end of each of said clamping plates to impart an outward force to said clamping plates;
two stop members respectively pivotally mounted on the bottom wall of said flat base panel at one lateral side relative to said bottom sliding grooves, each said stop member having a rear end, a front end and an engagement tooth at the front end; and
two biasing springs respectively mounted in the bottom wall of said flat bottom panel and stopped against the rear ends of said stop members to force the engagement teeth of said stop members into engagement with the longitudinal series of sloping teeth of said clamping plate.

2. The car computer/LCD monitor holder as claimed in claim 1, further comprising a vehicle computer/LCD monitor arm mountable on a part inside a car to support said bracket.

3. The car computer/LCD monitor holder as claimed in claim 2, wherein said vehicle computer/LCD monitor arm comprises a top mounting assembly pivotally connected to the bottom mount of said platform of said bracket and adjustably locked thereto by a locking mechanism thereof, a bottom mounting assembly for mounting on a part inside a car, and a plurality of links connected in series between said top mounting assembly and said bottom mounting assembly.
